(19) United States
(12) Patent Application Publication
(10) Pub. No.: US 2003/0150482 A1
(43) Pub. Date: Aug. 14, 2003

(54) Paper cleaning buff

(76) Inventor: Wayne K. Kaim, Lodi, WI (US)

Correspondence Address: LATHROP & CLARK LLP, 740 REGENT STREET SUITE 400, P.O. BOX 1507, MADISON, WI, 537011507

(21) Appl. No.: 10/072,863

(22) Filed: Feb. 9, 2002

(51) Int. Cl. B08B 1/02; B08B 7/00

(52) U.S. Cl. 134/122 R; 134/9

(57) ABSTRACT

A paper cleaning apparatus employs a paper buffing roll which has a lightweight hollow cylindrical core mounted between stub shafts. The stub shafts are mounted to bearings and the hollow core is arranged to be driven at approximately 3,450 to approximately 4,450 RPM. The surface of the cylindrical core is given a rough surface over which a wool cloth jacket is placed. The cloth sleeve is clamped in place by retaining end caps which fit over the stub shafts and clamp the sleeve against the ends of the hollow cylindrical core. The cloth sleeve is shrunk onto the surface of the cylindrical core with hot water or steam. The cloth sleeve is frayed to form a soft outer surface, with radially extending fibers.

### CROSS REFERENCES TO RELATED APPLICATIONS

Not applicable.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The present application relates to apparatus for cleaning a moving paper web in general and particularly to cleaners which affect the boundary layer of air moving with the paper web.

In a typical web offset press an image to be printed is transferred to a rubber blanket which is brought into contact with a moving web of paper onto which the image is printed. Minute amounts of loose fiber and dust from the paper web stick to the rubber blankets so that over time the blankets become dirty and must be cleaned to maintain image quality. It has been found that the frequency with which the rubber printing blankets must be cleaned can be substantially decreased if the paper web is precleaned before it is printed upon. In my earlier patent, U.S. Pat. No. 6,178,589, which is incorporated herein by reference, I disclosed an apparatus for cleaning the web which used an old but effective type of web cleaning roll. This existing web cleaning roll consisted of a central steel core on which multiple disks of cloth were compressed to form the roll surface. The surface of the roll, i.e. the cloth material was frayed to form a soft outer surface which is then worn in against a moving web. To effectively clean the web, an interaction between the cleaning rolls is uniformly established with the boundary layer of air which attaches to a moving web. This boundary layer which attaches to the paper web is only a small fraction of an inch thick. An ordinary web cleaner using only vacuum to remove fibers and dust from a paper begins to be ineffectual as paper speeds increase above 800 feet per minute (13 fps) because the boundary layer of air which moves with the paper web becomes more difficult to penetrate.

The buffing rolls are operated at relatively high speeds and, because of space limitations and overall cost, are relatively narrow in diameter—typically between three-and-one-half inches and four-and-one-half-inches in diameter. The fabric rings of the prior buffing rolls were constructed with only relatively narrow diameter cores, for example about 1.5 inches in diameter for a buff diameter of 4 inches. The same buffing rolls typically have a length of between 20 and 60 inches. The construction of the prior art buffing rolls which employ a solid central steel core overlain with disks of cloth results in some difficulty in assuring proper balance so that the cleaning rolls do not vibrate. If the central core is made too large in diameter, it can be difficult for maintenance people to handle the cleaning rolls. Further, renewing the soft outer surface of the rolls requires returning the rolls to the factory with the added cost of shipping to and from the factory.

What is needed is a paper cleaning roll which is lighter, stiffer, and which has a surface which can be renewed more readily.

### SUMMARY OF THE INVENTION

The paper cleaning apparatus of this invention employs a paper buffing roll which has a lightweight hollow cylindrical core mounted between stub shafts. The stub shafts are supported by bearings and the hollow core is arranged to be driven at approximately 3,450 to approximately 4,450 RPM. The surface of the cylindrical core is given a rough surface over which a wool cloth jacket is placed. The cloth jacket is clamped in place by retaining end caps which fit over the stub shafts and clamp the jacket against the ends of the hollow cylindrical core. The cloth jacket is shrunk onto the surface of the cylindrical core with hot water or steam. The cloth jacket is teased to raise fibers on the to form a soft outer surface.

It is a feature of the present invention to provide a paper cleaning apparatus with a buffing roll which may be easily resurfaced.

It is a further feature of the present invention to provide a paper cleaning apparatus with a buffing roll which is less subject to damage.

It is another feature of the present invention to provide a paper cleaning apparatus with a buffing roll which is less subject to vibration.

It is yet another feature of the present invention to provide a paper cleaning apparatus with a buffing roll which is intrinsically stiffer.

Further objects, features and advantages of the invention will be apparent from the following detailed description when taken in conjunction with the accompanying drawings.

### BRIEF DESCRIPTION OF THE DRAWINGS

FIG. 1 is a side elevational view of a paper cleaning apparatus incorporating the buffing rolls of this invention, placed by way of example in a printing press archway.

FIG. 2 is an side elevational view, partially broken away in section, and partly cut away, of a buffing roll of the apparatus of FIG. 1.

### DESCRIPTION OF THE PREFERRED EMBODIMENTS

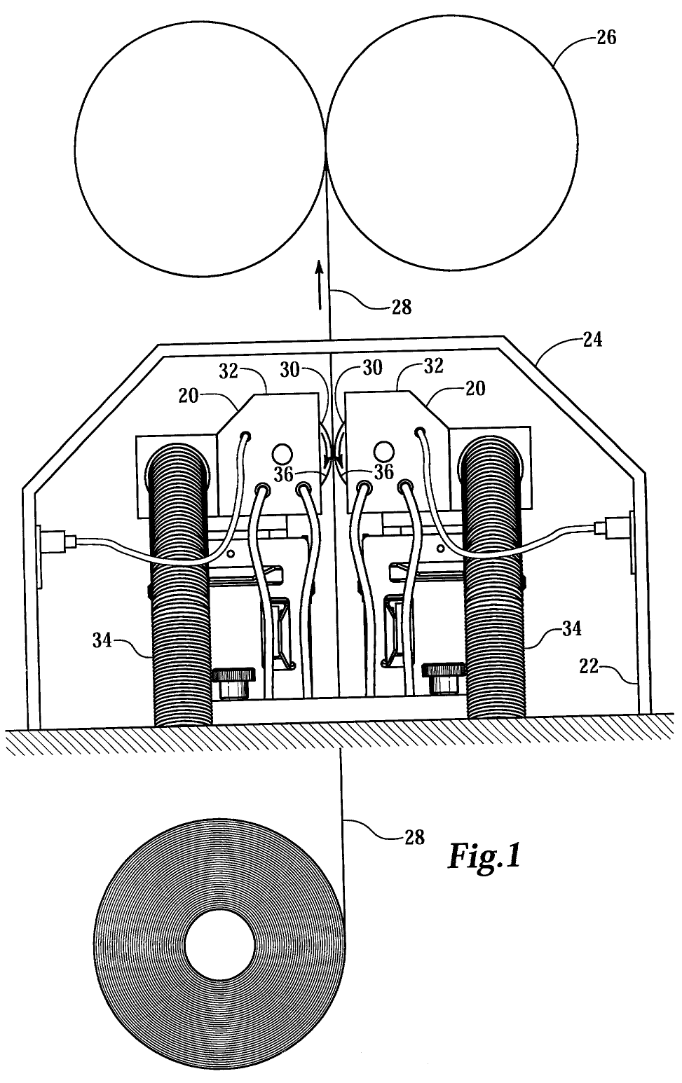

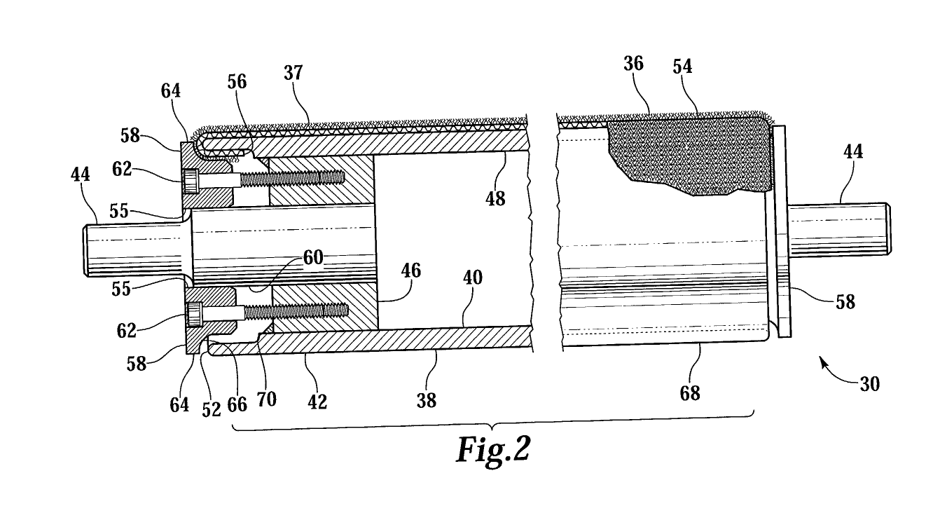

Referring more particularly to FIGS. 1-2, wherein like numbers refer to similar parts, a pair of buffing machines 20 are shown in FIG. 1, positioned within an archway 22 formed by a frame 24 of a printing press 26. A paper web 28 passes between opposed buffing rolls 30 which are mounted within vacuum hoods 32 which are connected to vacuum hoses 34. The buffing rolls 30 are rotated while air is drawn through the hoods 32. The rolls are rotated towards each other (one in the clockwise direction and one in the counter clockwise direction) in operation. As shown in FIG. 2, the buffing rolls 30 have a soft surface 36 composed of a profusion of radially extending wool fibers 37 which present a hairy surface. The fibers 37 and the air currents create interact with the boundary layer of air moving with the paper web 28, causing lose paper fibers and dust containing various components such as clay, starch or fiber particles to becoming entrained in the boundary layer attached to the buffing roll surface 36. The trapped particles are subsequently removed from the buffing roll 30 by a vacuum supplied by the hoses 34 to the vacuum hoods 32.

As shown in FIG. 2, the lightweight buffing roll 30 is constructed from a thin-walled cylinder 38 with a hollow interior 40. In the case of a 3½-inch diameter thin-walled aluminum cylinder 38 has walls 42 which are approximately ⅜th inches thick, and is joined to two opposed stainless steel stub shafts 44. The stub shafts 44 are sweated to aluminum plugs 46 which are then welded or bonded to the inside diameter 48 of the cylinder 38. Sweating refers to the process where one part is expanded by heating relative to another part and assembled so that when both parts are at the same temperature an interference fit is produced. Each stub shaft 44 has a thicker diameter portion 60 as shown in FIG. 2.

The aluminum plugs 46 are spaced inwardly of the cylinder ends 52, and are counterbored such that radiused cylindrical edges 52 which project outwardly from the plugs have a diameter of 3/16 inches. A wool jacket 54, about one-quarter inch in thickness, is placed around the cylinder 38, and the ends 56 of the wool jacket 54 are wrapped about the cylindrical edges 52 which are radiused to prevent cutting of the wool jacket 54. The wrapped ends 56 of the jacket 54 are clamped to the cylinder 38 by metal caps 58. Each cap 58 has a central bore 55 which slides along the thicker diameter portion 60 of the stub shafts 44. Four equally spaced screws 62 extend between the end caps 58 and threaded holes 59 in the aluminum plugs 46. Tightening the screws 62 draws the caps 58 axially inwardly toward the plugs 46.

The end caps 58 have radially protruding circumferential flanges 64 which define circumferential radiused features 66 opening towards the ends 52 of the cylinder 38. The ends 56 of the wool jacket 54 are clamped between the flanges 64 and the cylindrical edges 52, to be held in place within the radius conforming features 66. The wool sleeve or jacket 54 is approximately one-quarter inch in radial thickness and initially fits easily over the surface 68 of the aluminum cylinder 38. The wool jacket 54 is heated with steam or hot water and dried. This process causes the wool jacket 54 to shrink and grip the aluminum cylinder 38 tightly and to become affixed to the surface without bonding thereto. Following the shrinking process the ends 56 of the wool jacket 54 are bent over the cylindrical edges 52 and clamped in place by the end caps 58. The surface 68 of the aluminum cylinder 38 may be shot peened to produce a rough surface to which the wool jacket 54 attachment is enhanced when the wool fibers in the jacket shrink. The jacket may be a tubular woven cloth material, for example woven essentially of wool. A suitable wool jacket may be obtained from Edward H. Best & Co., Hanover, Mass., particularly All Wool Endless Jacket products.

The wool jacket 54 has an outer surface 36 from which multiple radially extending fibers 37 project. The number of radially extending fibers 37 may be increased by teasing or brushing the surface 36 of the roll 30 with, for example, a wire brush. In use, the ends of the fibers 37 should be tangent to the web 28. Correct positioning of the fibers 37 with respect to the web 28 is accomplished by positioning the rolls so that they contact the paper web 28 and allowing the paper web over a period of four to twenty-four hours to seat in or wear away the fibers which actually frictionally engage the surface of the paper web 28, after which the buffing rolls 30 can be considered to be in noncontact with the paper web, because no further wearing against the paper occurs. The buffing roll surface 36 is noncontact with the moving paper web. Surface 36 moves in a direction opposite to the direction of the paper web 28. In practice a gap between the roll surface 36 and the paper web 28 of as much as a 1/32th or even 1/16th of an inch, will not prevent the cleaning action. A contact roll on the other hand moves in the same direction with the same or similar speed as the web the contact roll is in contact with, or the contact roll produces significant frictional engagement with the web because of the contact combined with the relative motion between the contact roll and the web.

To create the proper buff boundary layer of air it is important that the surface velocity of the roll surface 36 be approximately in the range of 60 to 80 fps, in a direction opposite that of the paper web 28 which is moving typically at a velocity in excess of 25 fps to typically about 40 fps. For a roll with a total diameter of approximately four inches, this implies a rotation speed of between 3,450 RPM and 4,600 RPM. For a buffing roll 30 with an overall diameter of four and one half inches, the rotational speed may be proportionately about 12½ percent less. Rotating a cylinder sixty or more inches long at upwards of 4000 RPM without significant vibration is difficult. The tendency of a rotating core to vibrate depends on the square root of the spring constant of the system divided by the mass of the system.

By increasing the diameter of the core over the prior art and substantially decreasing the mass by constructing the core of lightweight materials and by making the core hollow, the buffing roll is rendered substantially stiffer and substantially of lower mass, thus increasing the spring constant, of the spring mass system which represents the spinning core, and decreasing the mass. Increasing the spring constant and decreasing the mass both contribute to decreased vibration.

To replace the the wool jacket 54, the screws 62 are loosened to allow the end caps 58 to slide away from the edges 52 of the roll cylinder 38 and unclamp the ends 56 of the wool jacket 54. Once the old wool jacket 54 is no longer clamped at its ends, it is removed by slitting it axially with a utility knife. A new jacket is then slid over the surface 68 of the aluminum cylinder. The wool jacket 54 is heated with steam or hot water and dried. This process causes the wool jacket 54 to shrink and grip the aluminum cylinder. Following the shrinking process, the ends 56 of the wool jacket 54 are bent over the cylindrical edges 52 and clamped in place by the end caps 58 . The surface 36 of the roll 30 is then developed as necessary by wire brushing, and the buffing rolls 30 are installed and worn in.

It should be understood that the roll could be constructed of any relatively strong lightweight material, particularly a composite hollow core could be used, in particular one constructed of graphite epoxy. Other roll surface coatings or jackets of other fibers could be used, either natural plant or animal fibers or synthetic fibers. Various methods of clamping or otherwise holding a fiber jacket to the surface of the roll could be employed.

It should also be understood that the buffing rolls 30 should be balanced to a relatively high degree. The balancing of rotating or spinning objects is well understood by those skilled in the art. The rolls 30 shown in FIG. 2 may, for example, be balanced by removing material from the aluminum plugs 46 along the radial surface 70 through which the threaded holes 59 are drilled, although other techniques known to those skilled in the art could be used.

It should be understood that the term “thin-walled” when used to describe a cylinder or pipe is used in its ordinary technical meaning of a wall thickness which is less than or around 1/10 the diameter of the cylinder or pipe.

It should be understood that two buffing rolls 30 may be placed opposite each other as shown in FIG. 1 to clean both sides of the paper web 28 or a single buffing roll may be positioned opposite a backing roll to clean one side of a paper web. A second single buffing roll opposite a second backing roll can then be used to clean a second side of the paper web.

It should be understood that the vacuum hood 32 preferably will include a number of vacuum slots which are positioned adjacent axially extending bars which closely approach the surface 36 of the buffing rolls 30 and interact with the boundary layer of the buffing roll to knock fibers and dust from the buffing roll. These bars may be spaced at 60, 90 or 180 degrees from the point at which the roll 30 is tangent to the web 28, and oriented tangent or perpendicular to the buffing roll 30.

It is understood that the invention is not limited to the particular construction and arrangement of parts herein illustrated and described, but embraces all such modified forms thereof as come within the scope of the following claims.

I claim:

1. A paper web cleaning apparatus of the type comprising a first paper buffing roll and a second paper buffing roll in closely spaced parallel relation to the first paper buffing roll, the first paper buffing roll and the second paper buffing roll mounted to rotate towards each other, each buffing roll associated with a hood connected to a vacuum system, and a paper web passes between the first paper buffing roll and the second paper buffing roll so as to be equally spaced from the first paper buffing roll and the second paper buffing roll, wherein the improvement comprises:
the first paper buffing roll comprising a hollow core having a cylindrical surface and mounted for rotation between stub shafts, a material jacket positioned about the hollow core and clamped between opposed end caps to the ends of the hollow core, the jacket material being affixed to the hollow core surface and having a soft outwardly facing surface with a profusion of radially protruding fibers developed thereon.

2. The paper cleaning apparatus of claim 1 wherein the jacket is constructed essentially of wool.

3. The paper cleaning apparatus of claim 1 wherein the hollow core is constructed of aluminum.

4. The paper cleaning apparatus of claim 1 wherein the core surface is rough.

5. A paper web cleaning apparatus of the type comprising a paper buffing roll in closely spaced parallel relation to a paper web, the paper buffing roll mounted for rotation and enclosed within a hood connected to a vacuum system wherein the improvement comprises:
the paper buffing roll comprising a hollow core, having a core surface, the hollow core mounted for rotation between stub shafts, a jacket positioned about the hollow core and the jacket material being held but not bonded to the core surface and having a soft outwardly facing surface having a profusion of radially outwardly projecting fibers developed thereon.

6. The paper cleaning apparatus of claim 5 wherein the jacket is constructed essentially of wool.

7. The paper cleaning apparatus of claim 5 wherein the hollow core is constructed of aluminum.

8. The paper cleaning apparatus of claim 5 wherein the core surface is rough.

9. A method of cleaning a paper web comprising the steps of:
fabricating a core from a thin-walled cylinder approximately 20 to approximately 60 inches long between bearing supports, and at least about 3½ inches in diameter;
balancing the core about an axis defined by the bearing supports;
placing a woven wool jacket about the core;
shrinking the wool jacket until it tightly engages the core;
developing a soft surface having a profusion of radially extending fibers on the wool jacket;
placing the core within a vacuum hood, drawing a vacuum on the hood and driving the core to rotate;
placing the soft radially extending fiber surface on the wool jacket in close touching engagement to a surface of a paper web, which is moving in a direction opposed to the surface velocity of the roll, at a velocity in excess of 16 fps, to wear the surface into tangential engagement with the paper surface;
continuing to operate the core within the vacuum hood, while drawing a vacuum on the hood and driving the core to rotate so as to produce an effective surface velocity to clean the paper web, moving in excess of 16 fps.

10. The method of claim 9 wherein the the affective surface velocity is approximately 60 to approximately 80 fps.

11. The method of claim 9 further comprising replacing the wool jacket by the steps of:
cutting the wool jacket along an axial direction defined by the thin-walled cylinder;
shrinking a new wool jacket until it tightly engages the core;
developing a profusion of soft radially extending fibers on the new wool jacket;
placing the core within a vacuum hood, drawing a vacuum on the hood and driving the core to rotate;
placing the soft radially extending fiber surface on the wool jacket in close touching engagement to a surface of a paper web, which is moving in a direction opposed to the surface velocity of the roll, to wear the surface into tangential engagement with the paper surface;
continuing to operate the core within the vacuum hood, while drawing a vacuum on the hood and driving the core to rotate so as to produce an effective surface velocity to clean the paper web.

12. A method of cleaning a surface of a paper web wherein the paper web is moving in a first direction at the velocity of at least 16 feet per second, the method comprising the steps of:
fabricating a core from a hollow cylinder at least 20 inches long between bearing supports, and at least about 3½ inches in diameter;
balancing the core about an axis defined by the bearing supports;
placing a jacket about the core;
shrinking the jacket until it tightly engages the core;
developing a soft surface having a profusion of radially extending fibers on the jacket;
placing the core within a vacuum hood, drawing a vacuum on the hood and driving the core to rotate with a surface velocity of between about 60 and about 80 feet per second in a direction opposite the first direction;
placing the soft radially extending fiber surface on the jacket in close tangential engagement to the surface of the paper web to interact with a boundary layer carried along with the paper web to remove particles from the surface of the paper web.
